(19) United States
(12) Patent Application Publication
(10) Pub. No.: US 2003/0221897 A1
(43) Pub. Date: Dec. 4, 2003

(54) Rear wheel steering device for a vehicle

(75) Inventors: Akiya Taneda, Anjo-shi (JP); Takamichi Nakaishi, Toyota-shi (JP)

Correspondence Address: BURNS, DOANE,SWECKER & MATHIS, L.L.P., P.O. Box 1404, Alexandria, VA, 22313-1404, US

(73) Assignee: AISIN SEIKI KABUSHIKI KAISHA

(21) Appl. No.: 10/375,263

(22) Filed: Feb. 28, 2003

(30) Foreign Application Priority Data
Feb. 28, 2002 (JP) 2002-054042

(51) Int. Cl. B62D 5/04

(52) U.S. Cl. 180/445

(57) ABSTRACT

A rear wheel steering device for a vehicle is comprised of a steering mechanism connected to rear wheels of a vehicle, an electric actuator having a coil portion and a rotor portion for driving the steering mechanism, and a transmission mechanism connected to the rotor portion for transmitting drive force of the electric actuator to the steering mechanism. The transmission mechanism includes a ball screw mechanism and a clutch mechanism for transmitting force from the electric actuator.

### FIELD OF THE INVENTION

This invention relates to a rear wheel steering device for a vehicle which operates steering of rear wheels of the vehicle by power provided by an electric motor.

### BACKGROUND OF THE INVENTION

A rear wheel steering device for a vehicle is applied for a reduction of a turning radius at low speed or improvement of driving stability when towing a boat etc. with a large vehicle by varying a steering angle of rear wheels of the vehicle. A known device for this rear wheel steering device is disclosed in Japanese Patent Laid-Open Publication No.61-196870. Two mechanisms for moving tie rods are disclosed in the known device. One mechanism of the known device in the publication has an electric motor attached at a body portion near a central position of a rear portion of the vehicle and steers rear wheels of the vehicle by moving tie rods connected to knuckle arms of the rear wheels by using a slider for converting a rotation of a threaded rod connected directly to an output shaft of the electric motor to an axial movement of a drive shaft. Another mechanism disclosed in the publication controls the tie rods by combining a worm gear connected directly to the output shaft of the electric motor and a worm wheel engaged with the worm gear. In addition, with regard to a structure of the electric motor as a drive source, a rear wheel steering device of an electric motor having a hollow rotation shaft is disclosed in Japanese Patent Laid-Open Publication No. 07-47963.

The rear wheel steering device for the vehicle must provide a stable driving consistently without turning the rear wheels even when external force is applied to the rear wheels. For this reason, a mechanism is usually provided to block force coming from an opposite direction of a transmission direction from a drive source. More specifically, the mechanism is applied to prevent the transmission of the external force by obtaining high reduction gear ratio by combining gears such as a worm gear and a worm wheel. When this type of mechanism is applied to the rear wheel steering device, an electric motor, which corresponds to a drive source, outputs large drive force with relatively small power. However, since the transmission of the force by the worm gear and worm wheel causes a sliding contact in most of the time, power transmission efficiency is reduced to 50% or lower. Therefore, when applying these known devices to heavy duty vehicles such as large SUVs or pick-up trucks, a drive source with a large amount of energy must be applied to obtain a large output for steering rear wheels. Consequently, problems such as a reduction of fuel efficiency, a large-sized motor (a drive source) and a control circuit, and a cost increase arise.

Also, when a failure in an electric system occurs, it is desirable to provide a rear wheel steering device which can return the rear wheels to a neutral position which does not affect running of a vehicle instead of the rear wheels being turned. To achieve such a function, there is a device which returns the rear wheels to the neutral position every time steering is completed. However, such a device operates a return control to the neutral position even in a normal condition. Consequently, this increases a number of portions and the control is redundant.

### SUMMARY OF THE INVENTION

It is an object of the present invention to provide a rear wheel steering device for a vehicle having a mechanism which can transmit energy from a drive device such as an electric motor efficiently.

A further object of the present invention is to provide a rear wheel steering device for a vehicle which can return rear wheels of a vehicle to a neutral position by rotating a hollow rotor manually with a simple tool.

According to the present invention, a rear wheel steering device for a vehicle a rear steering mechanism connected to rear wheels of the vehicle an actuator having a rotor portion for driving the rear steering mechanism and a transmission mechanism connected to the rotor portion for transmitting drive force of the actuator to the rear steering mechanism and the transmission mechanism includes a ball screw mechanism and a clutch mechanism.

### BRIEF DESCRIPTION OF THE DRAWINGS

The foregoing and additional features and characteristics of the present invention will become more apparent from the following detained description considered with reference to the accompanying drawings in which like reference numerals designate like elements:

FIG. 1 is a cross-sectional view of a rear wheel steering device for a vehicle according to an embodiment of the invention;

FIG. 2 is an enlarged cross-sectional view of a ball screw mechanism and a clutch mechanism of the rear wheel steering device for a vehicle according to the embodiment of the invention;

FIG. 3 is a schematic view showing a condition in which the clutch mechanism of the rear wheel steering device for a vehicle is operated;

FIG. 4 is a schematic view showing a condition in which the clutch mechanism of the rear steering device for a vehicle is operated when inverse output is applied;

FIG. 5 is a schematic view of teeth of a sun gear of the rear wheel steering device for a vehicle used when rear wheels of a vehicle are returned to a neutral position; and

FIG. 6 is a schematic view of the rear wheel steering device for a vehicle showing a condition in which a tool is applied to return the rear wheels of the vehicle to the neutral position.

### DETAILED DESCRIPTION OF THE INVENTION

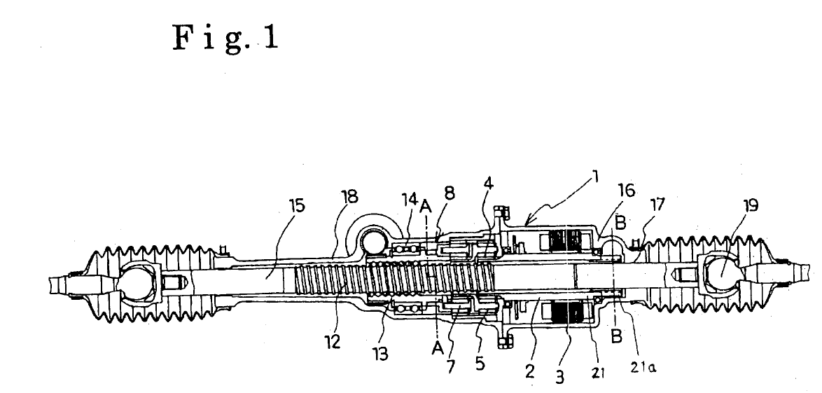

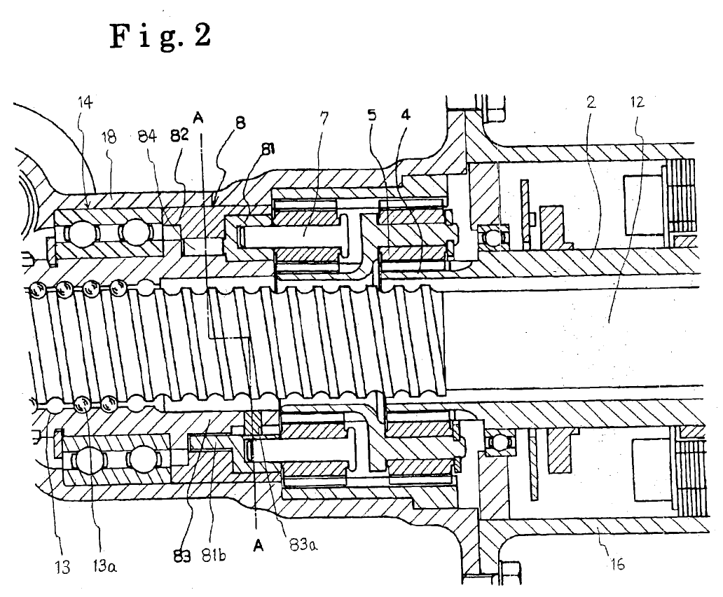

A rear steering mechanism for a vehicle according to an embodiment of the present invention will now be described with reference to the drawings. FIG. 1 and FIG. 2 are cross-sectional views showing a basic structure of the rear wheel steering device in an axial direction. A brush-less motor 1 (an electric actuator) having a hollow motor rotor 2 and a coil 3 is applied for a drive source of the rear wheel steering device. The brush-less motor 1 is connected to a control device (not shown) of a vehicle. A sun gear 4 is placed at a left-hand side in FIG. 1 of the motor rotor 2 of the brush-less motor 1.

Two sets of planetary gears 5 with two stages are placed at a rear stage of the sun gear 4 in order to increase torque. Rotation output of the sun gear 4 is transmitted to a retainer 81 (a retaining member) of a two-way clutch 8 through the planetary gears 5 engaged with the sun gear 4. A clutch mechanism applied to the rear wheel steering device of the present invention is structured to transmit force from a drive shaft. However, it does not transmit inverse input such as external force to the drive shaft side.

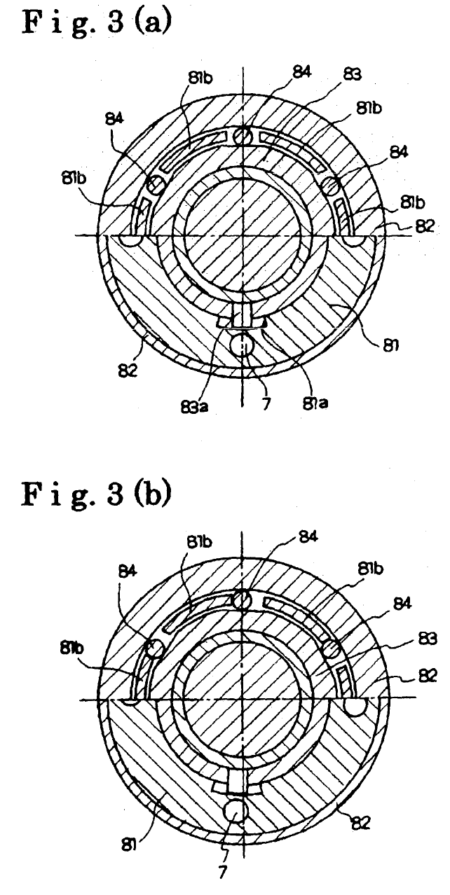

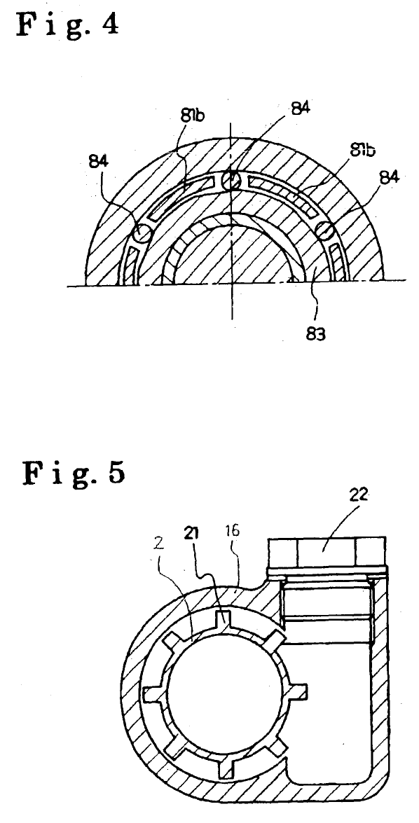

A basic structure and an operation condition of the clutch 8 will be described with reference to cross-sectional views of FIG. 3 and FIG. 4. FIG. 3(a) is a cross-sectional view of the clutch 8 taken along lines A-A shown in FIG. 1 and FIG. 2, and FIG. 3(a) shows a condition in which the force from the brush-less motor 1 is not transmitted. An outer race 82 of the clutch 8 is connected to a housing 18, and an inner peripheral surface of the outer race 82 is machined approximately in a cylindrical shape. An inner race 83 is formed integral with a female screw 13 of a ball screw portion to transmit force from the inner race 83 to a male screw 12 of the ball screw portion securely. An outer surface of a cylindrical outer peripheral surface of the inner race 83 is ground so that one portion of a space between the inner peripheral surface of the outer race 82 and the outer peripheral surface of the inner race 83 is formed to be larger than a diameter of a roller 84. A plurality of the cylindrical rollers 84 which are rotatable within the one portion of the space are placed at the one portion of the space between the outer race 82 and the inner race 83. Also, in the same space, a plurality of projections 81b having sector shapes are formed between the rollers 84 with equal intervals. These projections 81b and the retainer 81 are connected to each other to establish dimensional accuracy of the rollers 84.

In addition, the retainer 81 is also connected to a plurality of pins 7. These projections 81b and pins 7 may be fitted to the retainer 81 or may be formed integral with the retainer 81. In a condition shown in FIG. 3(a), the retainer 81 connected to the pins 7 which are connected to a rear stage of the two-staged planetary gears 5 is held still at a neutral point. Furthermore, since the retainer 81 is not rotating, a pin 83a connected to the inner race 83 (an inner member) is also held still at a position which is not in contact with a groove portion 81a of the retainer 81.

When the motor rotor 2 of the brush-less motor 1 starts rotating, the rotation speed is decelerated by the two-staged planetary gears 5 through the sun gear 4 at an end portion of the motor rotor 2, and the decelerated rotation force is transmitted to the pins 7 connected to the rear stage of the planetary gears 5. Furthermore, the rotation is transmitted to the retainer 81, and the retainer 81 connected to the pins 7 starts rotating. At the same time, the projections 81b start rotating as the retainer 81 rotates since the projections 81b are formed integral with the retainer 81. Then, the rollers 84 (shown in FIG. 3(b)) become in contact with the projections 81b, and the rollers 84 retained between the outer race 82 and the inner race 83 are moved to the one portion of the space between the outer race 82 and the inner race 83 which is larger than the diameter of the rollers 84. Thus, the rollers 84 become rotatable within the space. Moreover, since the groove portion 81a of the retainer 81 and the pin 83a connected to the inner race 83 become in contact with each other, the rotation force of the retainer 81 is transmitted to the inner race 83. On the other hand, output of the female screw 13 transmitted from the inner race 83 is retained rotatably through a bearing 14 fixed to the housing 18, and the rotation force is transmitted to a rod 15 which is integral with the male screw 12 threaded with the female screw 13.

On the other hand, the rod 15 is regulated not to rotate by a spline 17 formed in a motor cover 16 of the brush-less motor 1. Therefore, force applied to the rod 15 is converted into force in the axial direction, and the rear wheels are steered by transmission of the force of the rod 15 to tie rods 19 connected to both ends of the rod 15.

Next, inverse output by external force from the rear wheels of the vehicle will be described. The inverse output is a force in an opposite direction of a transmission direction from a drive source. The inverse output from the rear wheels is transmitted to the inner race 83 of the clutch mechanism formed integral with the female screw 13 of the ball screw portion through the male screw 12 of the ball screw portion formed integral with the rod 15. By the force of the inverse output, the inner race 83 starts rotating. However, as the force is transmitted to the inner race 83, the rollers 84 are moved to the other portion of the space between the outer race 82 and the inner race 83 which is formed narrower than the diameter of the rollers 84. As a result, the rollers 84 are held between the outer race 82 and the inner race 83. Thus, the force from the inner race 83 to the retainer 81 is not transmitted because of a wedge effect of the rollers 84. Thus, the transmission of the inverse output is blocked by the rollers 84.

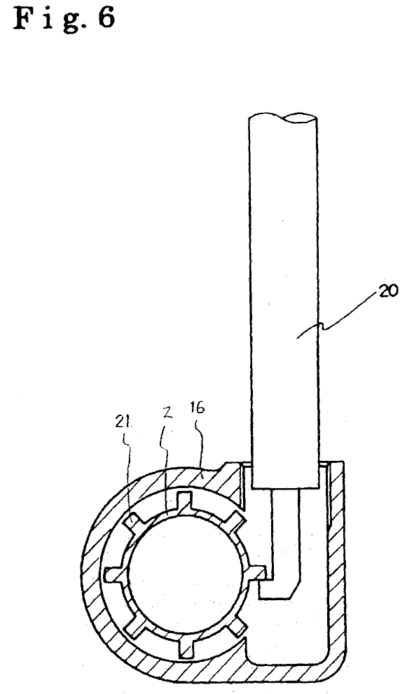

An operation to return the rear wheels to a neutral position when an electric failure in the brush-less motor (a drive source) or a control device occurs will be described with reference to FIG. 5 and FIG. 6 showing cross-sectional views taken along a line B-B of FIG. 1. Upon returning the rear wheels to the neutral position, the operation starts with opening a hexagonal faucet 22 attached to the motor cover 16 by a wheel nut etc. mounted at the vehicle. Next, the motor rotor 2 is rotated manually by pushing or pulling teeth 21 placed at the other end of the sun gear 4 of the motor rotor 2 by applying a tool 20 such as a jack handle etc. which is a shape of inverse L. By repeating this operation, the rear wheels of the vehicle can be returned to the neutral position manually by applying a simple tool. The faucet 22 of this embodiment is used for protecting the teeth 21 of the motor rotor 2 from water. Therefore, a shape of the faucet 22 can be any type as long as the faucet 22 can protect the teeth 21 from water. FIG. 5 shows a condition in which the faucet 22 is capped onto the housing 14 in a normal condition, and FIG. 6 shows a condition in which the tool 20 is in contact with one of the teeth 21 upon the operation to return the rear wheels to the neutral position when the electric failure occurs. By conducting the above operation, the rear wheels can be returned to the neutral position.

According to the present invention, as for a mechanism to transmit drive force of an electric actuator such as a brush-less motor, transmission of force is operated by ball screws and a clutch mechanism instead of applying a worm gear and worm wheel. Power transmission efficiency of the ball screws are 90% or higher in both directions, and thus input energy can be reduced to nearly 50% compared to the mechanism with a conventional worm gear and worm wheel. Furthermore, by forming an inner race corresponding to an inner member of the clutch mechanism of a transmission mechanism and a female screw portion of a ball screw portion integrally, a number of portions can be reduced, and unnecessary assembly can be eliminated. Also, when a failure in an electric system occurs, rear wheels that are turned can be returned to a neutral position manually by merely forming a plurality of teeth to a hollow rotor of the brush-less motor, opening a faucet of a housing cover, and applying a simple tool to push or pull the teeth. Therefore, an object can be achieved by a simple structure instead of applying a complicated structure or operating a redundant control. Moreover, by applying such a simple structure, an improvement of fuel efficiency, downsizing of an electric motor and controller, and a cost reduction can be achieved.

According to the present invention, by applying the ball screws, transmission efficiency can be doubled approximately compared to the mechanism applying a combination of a worm gear and worm wheel, or applying a slider which converts a rotation of a threaded rod into force in an axial direction. Thus, many improvements can be achieved.

What is claimed is:

1. A rear wheel steering device for a vehicle comprising;
a rear steering mechanism connected to rear wheels of the vehicle;
an actuator having a rotor portion for driving the rear steering mechanism; and
a transmission mechanism connected to the rotor portion for transmitting drive force of the actuator to the rear steering mechanism, wherein the transmission mechanism includes a ball screw mechanism and a clutch mechanism.

2. A rear wheel steering device for a vehicle according to claim 1, wherein the clutch mechanism includes an inner member, an outer member, and a retaining member rotated by drive force from the rotor portion, and the retaining member and the inner member are connected in response to the rotation of the retaining member.

3. A rear wheel steering device for a vehicle according to claim 2, wherein a roller member is movably arranged at a space formed between the outer member and the inner member.

4. A rear wheel steering device for a vehicle according to claim 3, wherein the roller member is placed at one portion of the space formed between the outer member and the inner member, a length of the center portion of the space in the radial direction is set to be larger than the diameter of the roller member for free movement of the roller member.

5. A rear wheel steering device for a vehicle according to claim 3, wherein a length of at the both end edge portion of the space in the radial direction is set to be smaller than the diameter of the roller member.

6. A rear wheel steering device for a vehicle according to claim 2, wherein the retaining member includes a release member projecting into the other portion of the space between the outer member and the inner member to move the roller member into the center portion of the space.

7. A rear wheel steering device for a vehicle according to claim 3, wherein a plurality of the roller members are arranged with equal intervals.

8. A rear wheel steering device for a vehicle according to claim 6, wherein a plurality of the release members are positioned with equal intervals between the roller members to move each of the roller members into the portion of the space simultaneously.

9. A rear wheel steering device for a vehicle according to claim 2, wherein the retaining member and the release members are formed integrally to transmit the force from the retaining member to the roller members.

10. A rear wheel steering device for a vehicle according to claim 2, wherein the inner member is formed integrally with a female screw portion of the ball screw mechanism to transmit the force from the inner member to the male screw portion of the ball screw mechanism.

11. A rear wheel steering device for a vehicle comprising;
a rear steering mechanism connected to rear wheels of the vehicle;
an actuator having a rotor portion for driving the rear steering mechanism; and
a transmission mechanism connected to the rotor portion for transmitting drive force of the actuator to the rear steering mechanism, wherein the transmission mechanism includes a ball screw mechanism, a clutch mechanism and a planetary gear sets.
